(19) United States
(12) Patent Application Publication
(10) Pub. No.: US 2008/0291192 A1
(43) Pub. Date: Nov. 27, 2008

(54) CHARGE RECYCLING SYSTEM OF LIQUID CRYSTAL DISPLAY AND CHARGE RECYCLING METHOD THEREOF

(76) Inventors: Chen-Hsien Han, Hsinchu City (TW); Wei-Shan Chiang, Tai-Chung City (TW); Jing-Chi Yu, Hsinchu City (TW); Meng-Yong Lin, Taipei City (TW); Chi-Mo Huang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/840,216

(22) Filed: Aug. 17, 2007

(30) Foreign Application Priority Data
May 25, 2007 (TW) 096118858

(51) Int. Cl. G06F 3/038

(52) U.S. Cl. 345/212

(57) ABSTRACT

A charge recycling system of a liquid crystal display includes a controller and at least one switch module. The controller outputs at least one control signal when driving signals of a gate line and a source line of the liquid crystal display are both disabled, and the switch module couples the source line to a voltage supply of a driving circuit of the liquid crystal display according to the control signal. In this way, charges stored in a liquid crystal unit coupled to the source line are recycled to the voltage supply of the driving circuit, therefore raising the utilization efficiency of charges of the liquid crystal display and lowering the power consumed by the liquid crystal display.

### BACKGROUND OF THE INVENTION

1. Field of the Invention

The present invention relates to a charge recycling system and a charge recycling method thereof, and more particularly, to a charge recycling system implemented in a liquid crystal display (LCD) and a charge recycling method thereof.

2. Description of the Prior Art

A conventional LCD comprises a plurality of thin film transistors (TFTs) arranged in a matrix, wherein sources of the TFTs in the same row are connected to the same source line, and through the source line, charges are stored in the capacitors (storage capacitor, parasitic capacitor and capacitor of LCD) coupled to the sources determining voltage levels of the TFTs. TFTs in each column are controlled by a gate line to be conducted in sequence. When the TFT is conducted, a corresponding LCD cell displays luminance according to the voltage level of the TFT; therefore, pictures having different colors can be shown on the LCD after the LCD cells are filtered by RGB filters.

However, charge utilization efficiency is a general problem that LCDs driven by the above driving method need to solve. Charges stored in the capacitors vanish through discharging routes naturally after the display of the TFTs are complete, and these insufficiently utilized charges make the power consumption problem of the LCD more serious.

### SUMMARY OF THE INVENTION

One objective of the present invention is to therefore provide a charge recycling system that raises utilization efficiency of charges of an LCD and lowers power consumed by the LCD by recycling charge that is not used in the LCD, and a charge recycling method thereof.

According to an exemplary embodiment of the present invention, a charge recycling system is disclosed. The charge recycling system comprises a controller and at least one switch module. The controller, coupled to at least one source line of an LCD, outputs at least one first control signal when driving signals of a gate line and the source line of the LCD are both disabled. The switch module is coupled to the controller and the source line, and is for coupling the source line to a voltage supply of at least one first driving circuit of the LCD according to the first control signal.

According to another exemplary embodiment of the present invention, a charge recycling method is disclosed. The charge recycling method comprises outputting at least one first control signal when driving signals of a gate line and a source line of an LCD are both disabled, and coupling the source line to a voltage supply of at least one first driving circuit of the LCD according to the first control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a charge recycling system implemented to recycle charges stored in LCD cells of an LCD according to an exemplary embodiment of the present invention.

FIG. 2 is a diagram of a charge recycling system implemented to recycle charges stored in LCD cells of an LCD according to another exemplary embodiment of the present invention.

FIG. 3 is a diagram illustrating relationships between driving signals of gate lines and a source line of an LCD, a polarity conversion signal of the LCD and a charge recycling enabling signal according to an exemplary embodiment of the present invention.

### DETAILED DESCRIPTION

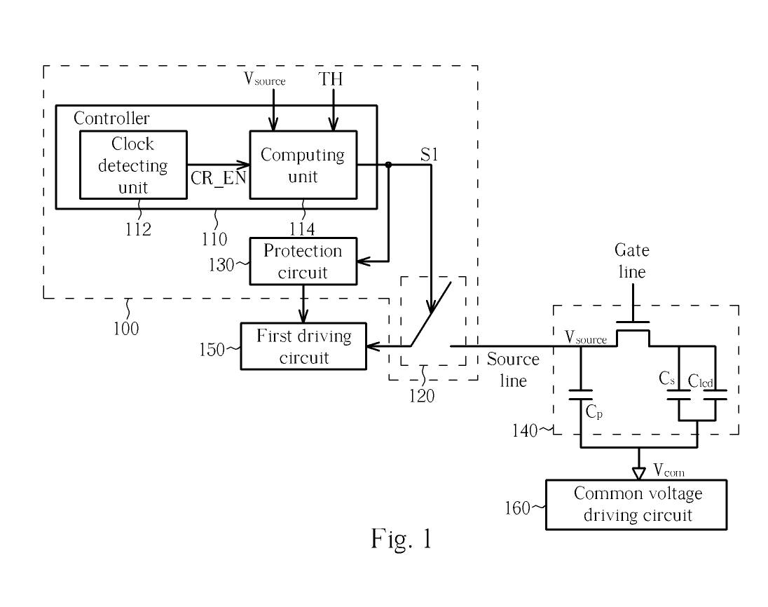

FIG. 1 is a diagram of a charge recycling system implemented to recycle charges stored in LCD cells of an LCD according to an exemplary embodiment of the present invention. Note that for clarity, FIG. 1 only shows an LCD cell 140; in fact, a source line of the LCD is coupled to a plurality of LCD cells arranged in the same row. The charge recycling system 100 comprises a controller 110, a switch module 120 and a protection circuit 130. The controller 110 comprises a clock detecting unit 112 and a computing unit 114, wherein the clock detecting unit 112 detects operations of a gate line and a source line corresponding to the LCD cell 140. When driving signals of the gate line and the source line corresponding to the LCD cell 140 are detected to be both disabled by the clock detecting unit 112—that is, the LCD cell 140 is off and display voltage corresponding to the next conduction is not inputted to the LCD cell 140—the clock detecting unit 112 outputs a charge recycling enabling signal CR_EN to the computing unit 114, which determines whether the charge recycling mechanism of the LCD cell 140 should be started. Please note that the clock detecting unit 112 also determines the timing to output the charge recycling enabling signal CR_EN to the computing unit 114 by detecting a polarity conversion signal of the LCD. (The polarity conversion signal is utilized to control the LCD cells to be driven in a positive polarity or a negative polarity, which is well known to those skilled in the art.). Therefore, the signal type detected by the clock detecting unit 112 is not limited.

In one embodiment, the computing unit 114 determines whether a cross voltage of the parasitic capacitor Cₚ in the LCD cell 140 (i.e. the difference between the voltage level V_{source} of the LCD cell 140 and a common voltage level V_{com}) is larger than a threshold TH, and outputs a first control signal S1 to the switch module 120 when the difference is larger than the threshold TH. The first control signal S1 is utilized to control the switch module 120 to couple the source line to a voltage supply (not shown) of a first driving circuit 150 of the LCD. Therefore, the threshold TH corresponds to the supply voltage of the first driving circuit 150. For example, when a voltage supply of the first driving circuit 150 is an outer voltage supply (VCI), the threshold can be chosen as the voltage level of VCI. In this way, when the difference between the voltage level V_{source} and the common voltage level V_{com} is larger than the voltage level of VCI, the switch module 120 couples the source line (i.e. a terminal of the parasitic capacitor Cₚ) to a storage circuit or a storage element such as a regulating capacitor of the outer voltage supply. Then, the parasitic capacitor Cₚ charges the regulating capacitor of the outer voltage supply, and charges stored in the parasitic capacitor Cₚ are recycled to the regulating capacitor. Hence, charging time required for the outer voltage supply to generate a voltage level supplied to the inner circuits of the LCD (for example, a source driving circuit or a gate driving circuit of the LCD) can be shortened and the power consumed can be reduced because the regulating capacitor has already been partly charged. Although the threshold TH is chosen to be the supply voltage level of the first driving circuit 150 in this embodiment, the threshold TH can be adjusted according to system requirements.

Moreover, when the first driving circuit 150 is a source driving circuit, one of the voltage supplies of the first driving circuit 150 is a DDVDH driving circuit that provides DDVDH that is two times of VCI, exceeding the possible maximum difference between the voltage level V_{source} and the common voltage level V_{com}. In this situation, the controller 110 further controls a common voltage driving circuit 160 to change the common voltage level V_{com} when outputting the first control signal S1. For example, the common voltage level V_{com} is boosted by a VCI momentarily when the first control signal S1 is outputted, causing the voltage level V_{source} to boost by a VCI and momentarily be higher than DDVDH. By doing this, the parasitic capacitor Cₚ can charge the regulating capacitor of the source driving circuit and recycle the charges stored in the parasitic capacitor Cₚ to the regulating capacitor.

At the same time when the controller 110 outputs the first control signal S1 to the switch module 120, the first control signal S1 is sent to the protection circuit 130 by the controller 110 to selectively turn off at least part of circuit elements of the first driving circuit 150. The objective of turning off at least part of circuit elements of the first driving circuit 150 is to ensure that the charges stored in the parasitic capacitor Cₚ will be recycled to the storage circuit or storage element of the voltage supply of the first driving circuit, instead of flowing through unexpected paths and affecting operations of the first driving circuit 150 or other circuits. In addition, this can save power as well. In one preferred embodiment, all active elements (such as transistors or amplifiers) of the first driving circuit 150 are disabled when charges are recycled. Note that the implementation of the protection circuit 130 is not limited in this invention. The protection circuit 130 can be a switch circuit composed of transistors, or any other known switch circuits able to selectively turn other circuits on and off. The protection circuit 130 and the switch module 120 are both driven by the first control signal S1, meaning that the protection circuit 130 and the switch module 120 are enabled only when the charge recycling mechanism is active. When the charge recycling mechanism is complete, the protection circuit 130 and the switch module 120 return to their original states, turning on the part elements of the first driving circuit 150 which were turned off during charge recycling, and uncoupling the source line from the first driving circuit 150 to return the LCD to its normal operating process.

In the embodiment shown in FIG. 1, the voltage supply of the first driving circuit 150 can be a driving circuit providing a positive power or a driving circuit providing a negative power; in other words, the charge utilization efficiency can be raised and the power consumption can be reduced if any circuit related to power supply in a conventional LCD applies the charge recycling mechanism shown in FIG. 1. Moreover, the charge recycling mechanism provided by the present invention can be applied to driving circuits providing different voltage levels. For example, the charge recycling mechanism can be applied to a driving circuit providing a positive power and a driving circuit providing a negative power, respectively.

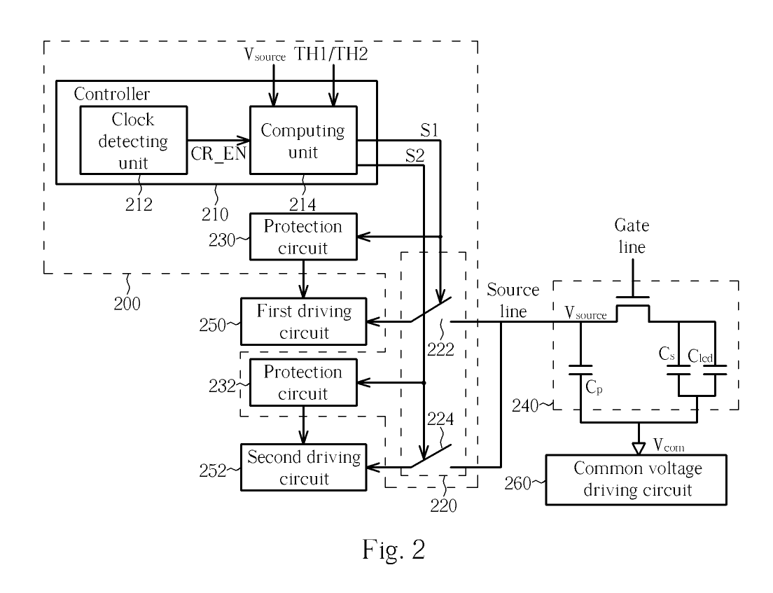

FIG. 2 shows a diagram of a charge recycling system implemented to recycle charges stored in LCD cells of an LCD according to another exemplary embodiment of the present invention. Note that for clarity, FIG. 2 only shows one LCD cell 240. Different from the charge recycling system 100 shown in FIG. 1, the controller 210 selectively outputs a first control signal S1 or a second control signal S2 according to driving polarity of the LCD cell 240 when driving signals of a gate line and a source line corresponding to the LCD cell 240 are both detected to be disabled. The switch module 220 comprises a first switch 222 and a second switch 224, wherein the first switch 222 is coupled to a voltage supply of a first driving circuit 250 and the second switch 224 is coupled to a voltage supply of a second driving circuit 252. When receiving the first control signal S1 outputted by the controller 210, the first switch 222 couples the source line corresponding to the LCD cell 240 to a storage circuit or a storage element (such as a regulating capacitor) of the voltage supply of the first driving circuit 250. Similarly, when receiving the second control signal S2 outputted by the controller 210, the second switch 224 couples the source line corresponding to the LCD cell 240 to a storage circuit or a storage element (such as a regulating capacitor) of the voltage supply of the second driving circuit 252. Therefore when the first driving circuit 250 is a driving circuit providing a positive power (e.g. the outer voltage supply VCI or the source driving circuit DDVDH mentioned before) and the second driving circuit 252 is a driving circuit providing a negative power (e.g. a negative voltage driving circuit VCIM providing −VCI voltage level), the controller 210 recycles charges to the voltage supply of the first driving circuit 250 or the second driving circuit 252, respectively, according to the positive/negative polarity of the recycled charges. In one embodiment, after the clock detecting unit 212 outputs the charge recycling enabling signal CR_EN to the computing unit 214, the computing unit 214 not only determines whether the difference between the voltage level V_{source} and the common voltage level V_{com} is larger than a threshold TH1 or TH2, but also determines the sign of the value (V_{source}−V_{com}). Please note that the thresholds TH1 and TH2 are corresponding to the supply voltages of the first driving circuit 250 and the second driving circuit 252, respectively. For example, when the voltage supply of the first driving circuit 250 is the outer voltage supply VCI, the threshold TH1 is chosen to be the voltage level of VCI. When the difference is larger than the threshold TH1 (VCI) and (V_{source}−V_{com}) is positive, the computing unit 214 outputs the first control signal S1 to control the first switch 222 to couple the source line to the first driving circuit 250 in order to recycle the positive charges stored in the parasitic capacitor Cₚ to the regulating capacitor of the first driving circuit 250. In another example, when the second driving circuit 252 is the negative voltage driving circuit VCIM, then threshold TH2 is chosen to be the absolute value of VCIM. In this situation, when the difference is larger than the threshold TH2 and (V_{source}−V_{com}) is negative, the computing unit 214 outputs the second control signal S2 to control the second switch 224 to couple the source line to the second driving circuit 252 in order to recycle the negative charges stored in the parasitic capacitor Cₚ to the regulating capacitor of the second driving circuit 252.

The common voltage driving circuit 260 is coupled to a plurality of LCD cells and provides the common voltage level V_{COM}. As mentioned above, the common voltage level V_{COM} can be appropriately adjusted to accomplish the charge recycling. For example, the common voltage level V_{COM} can be boosted or lowered according to system design to accomplish the recycling of positive charges or negative charges, respectively. Since a person skilled in the art can easily appreciate the adjusting mechanism of the common voltage level V_{COM} after reading above disclosure, detailed description is omitted here for brevity.

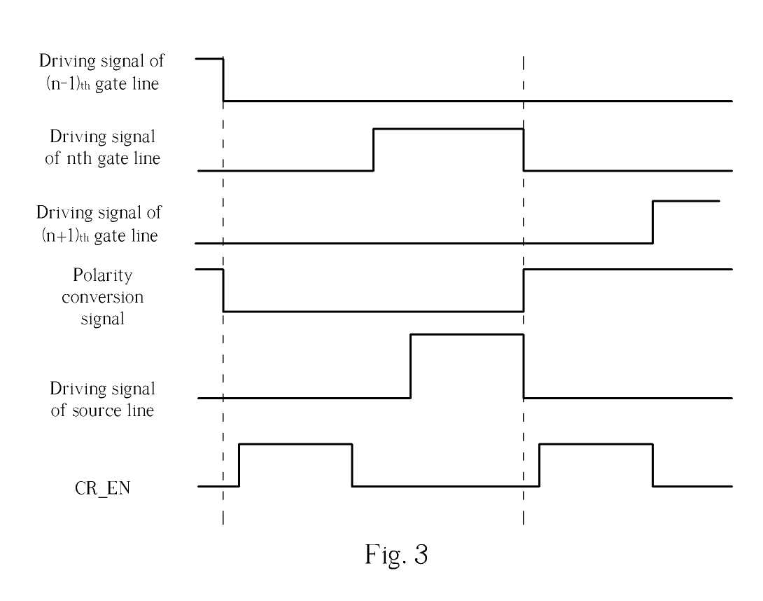

For clarity, the above embodiments only take one LCD cell 140 (240) as an example to explain the operation of the charge recycling system 100 (200). In fact, the charge recycling system 100 (200) recycles charges stored in a plurality of LCD cells coupled to the source line. Please refer to FIG. 3, which illustrates relationships between driving signals of gate lines and the source line of the LCD, the polarity conversion signal of the LCD and the charge recycling enabling signal according to an exemplary embodiment of the present invention. As shown in FIG. 3, when scanning of the (n−1)^{th} gate line is complete and scanning of the n^{th} gate line and the source line are not started (the above-mentioned disable state), the clock detecting unit 112 (212) of the charge recycling system 100 (200) outputs the charge recycling enabling signal CR_EN to the computing unit 114 (214). The computing unit 114 (214) is therefore signaled to determine whether charges stored in the LCD cells corresponding to the n^{th} gate line and the source line can be recycled. Note that the charge recycling mechanism must be done before the n^{th} gate line starts to scan in order not to affect the display of the LCD cell. Then, when scanning of the n^{th} gate line is complete and scanning of the (n+1)^{th} gate line and the source line are not started, the clock detecting unit 112 (212) outputs the charge recycling enabling signal CR_EN to the computing unit 114 (214) again to instruct the computing unit 114 (214) to determine whether charges stored in the LCD cells corresponding to the (n+1)^{th} gate line and the source line can be recycled. Each time the charge recycling mechanism is enabled, the computing unit 114 (214), the switch module 120 (220) and the protection circuit 130 (230,232) operate as described in the above embodiments. Those skilled in the art should appreciate how to implement the charge recycling system 100 (200) to a plurality of LCD cells, therefore further description is omitted here for brevity.

In the above embodiments, each source line is coupled to a charge recycling system. However, if the size or cost of LCD is restricted, these charge recycling systems may not be so suitable. A modified charge recycling system based on the charge recycling system 100 and 200 has a plurality of source lines utilizing a single (common) controller, but couples each source line to a switch module which is utilized to couple the source line to the first driving circuit or the second driving circuit. The clock detecting unit detects the gate lines and the source lines and outputs a charge recycling enabling signal when driving signals of a gate line and source lines are disabled. However, the computing unit computes an average voltage level of the source lines, and determines whether a difference between the average voltage level and the common voltage level is larger than a threshold when receiving the charge recycling enabling signal. When the difference is larger than the threshold, the first control signal or the second control signal is outputted to the first switch or the second switch of each switch module to couple the source lines to the first driving circuit or the second driving circuit. In this way, size, complexity and cost of the charge recycling system are significantly reduced while the charge utilization efficiency of LCD is still increased.

Those skilled in the art will readily observe that numerous modifications and alterations of the device and method may be made while retaining the teachings of the invention.

What is claimed is:

1. A charge recycling system, comprising:
a controller, coupled to at least one source line of a liquid crystal display, for outputting at least one first control signal when driving signals of a gate line and the source line of the liquid crystal display are disabled; and
at least one switch module, coupled to the controller and the source line, for coupling the source line to a voltage supply of at least one first driving circuit of the liquid crystal display according to the first control signal.

2. The charge recycling system of claim 1, wherein the controller comprises:
a clock detecting unit, for detecting operations of the gate line and the source line, and outputting a charge recycling enabling signal when the driving signals of the gate line and the source line are disabled; and
a computing unit, coupled to the clock detecting unit and the source line, for determining whether a difference between a voltage level of the source line and a common voltage level is larger than a threshold when receiving the charge recycling enabling signal, and outputs the first control signal when the difference is larger than the threshold.

3. The charge recycling system of claim 2, wherein the threshold is a VCI voltage level, a DDVDH voltage level or a VCIM voltage level utilized by the liquid crystal display.

4. The charge recycling system of claim 2, wherein when the controller is coupled to a plurality of source lines, the computing unit is coupled to the clock detecting unit and the plurality of source lines, and determines whether a difference between an average voltage level of the plurality of source lines and the common voltage level is larger than the threshold when receiving the charge recycling enabling signal, and outputs the first control signal when the difference is larger than the threshold.

5. The charge recycling system of claim 1, wherein the first driving circuit is a source driving circuit of the liquid crystal display, and the controller further controls a common voltage driving circuit to change a common voltage level outputted by the common voltage driving circuit when outputting the first control signal.

6. The charge recycling system of claim 1, further comprising:
a protection circuit, coupled to the first driving circuit, for selectively turning off at least a circuit element in the first driving circuit according to the first control signal.

7. The charge recycling system of claim 1, wherein the controller further selectively outputs the first control signal or a second control signal according to a driving polarity of a liquid crystal display cell corresponding to the source line and the gate line when the driving signals of the gate line and the source line are disabled, and the switch module comprises:
a first switch, coupled to the controller and the first driving circuit, for coupling the source line to a first capacitor of the first driving circuit when receiving the first control signal; and
a second switch, coupled to the controller and a second driving circuit of the liquid crystal display, for coupling the source line to a second capacitor of the second driving circuit when receiving the second control signal.

8. The charge recycling system of claim 7, wherein the first driving circuit is a source driving circuit of the liquid crystal display, and the second driving circuit is a common voltage driving circuit of the liquid crystal display.

9. A charge recycling method, comprising:
outputting at least one first control signal when driving signals of a gate line and a source line of a liquid crystal display are disabled; and
coupling the source line to a voltage supply or a charge storage element of at least one driving circuit of the liquid crystal display according to the first control signal.

10. The charge recycling method of claim 9, wherein the step of outputting at least one first control signal comprises:
detecting operations of the gate line and the source line;
determining whether a difference between a voltage level of the source line and a common voltage level is larger than a threshold when the driving signals of the gate line and the source line are disabled; and
outputting the first control signal when the difference is larger than the threshold.

11. The charge recycling method of claim 10, wherein the threshold is a VCI voltage level, a DDVDH voltage level or a VCIM voltage level utilized by the liquid crystal display.

12. The charge recycling method of claim 9, wherein the step of outputting at least one first control signal comprises:
detecting operations of the gate line and the source line;
determining whether a difference between an average voltage level of a plurality of source lines and a common voltage level is larger than the threshold when the driving signals of the gate line and the source line are disabled; and
outputting the first control signal when the difference is larger than the threshold.

13. The charge recycling method of claim 9, wherein the first driving circuit is a source driving circuit of the liquid crystal display, and the charge recycling method further comprises controlling a common voltage driving circuit to change a common voltage level outputted by the common voltage driving circuit when outputting the first control signal.

14. The charge recycling method of claim 9, further comprising:
selectively turning off at least a circuit element in the first driving circuit according to the first control signal.

15. The charge recycling method of claim 9, wherein when the driving signals of the gate line and the source line are disabled, the charge recycling method further comprises selectively outputting the first control signal or a second control signal according to a driving polarity of a liquid crystal display cell corresponding to the source line and the gate line, and coupling the source line to a voltage supply of a second driving circuit of the liquid crystal display according to the second control signal.

16. The charge recycling method of claim 15, wherein the first driving circuit is a source driving circuit of the liquid crystal display, and the second driving circuit is a common voltage driving circuit of the liquid crystal display.
